(19) United States
(12) Patent Application Publication
(10) Pub. No.: US 2024/0417827 A1
(43) Pub. Date: Dec. 19, 2024

(54) METHODS FOR EXTRACTING RARE EARTH ELEMENTS FROM ION-ADSORPTION CLAYS

(71) Applicant: Virginia Tech Intellectual Properties Inc., Blacksburg, VA (US)

(72) Inventors: Christopher Aaron NOBLE, Blacksburg, VA (US); Roe-Hoan YOON, Blacksburg, VA (US)

(21) Appl. No.: 18/815,220

(22) Filed: Aug. 26, 2024

Related U.S. Application Data
(63) Continuation of application No. PCT/US2023/063135, filed on Feb. 23, 2023.
(60) Provisional application No. 63/268,607, filed on Feb. 27, 2022.

(51) Int. Cl. C22B 59/00; C22B 1/11; C22B 3/14; C22B 3/18

(52) U.S. Cl. CPC C22B 59/00; C22B 1/11; C22B 3/14; C22B 3/18

(57) ABSTRACT

Methods of extracting rare earth elements (REEs) from low-grade REE sources composed of clayey materials. In one aspect, the REE sources are the waste materials generated in the coal and kaolin clay industries during the courses of upgrading mined coal and kaolinite. The methods described herein include the steps of pre-concentrating REE-bearing minerals using physical separation methods to prepare high-grade feedstocks for the chemical extraction of high-value REEs and critical materials while minimizing both the capital and operating costs.

### CROSS REFERENCE TO RELATED APPLICATIONS

This application is a continuation of PCT/US2023/063135, filed on Feb. 23, 2023, which claims the benefit of U.S. Provisional Application No. 63/268,607, filed on Feb. 27, 2022, both of which are fully incorporated herein by reference.

### STATEMENT REGARDING FEDERALLY SPONSORED RESEARCH OR DEVELOPMENT

This invention was made with U.S. Government support under Grant Number DE-FE0029900 awarded by the US Department of Energy. The government has certain rights in the invention.

### BACKGROUND

In 2020, the global mine production of rare earth oxides (REOs) was 240,000 metric tons, with China accounting for 58.3%, followed by the U.S. (15.8%), Burma (12.5%), Australia (7.1%) and other countries (6.3%) (USGS, 2021). Much of the mine production in the U.S. and Burma of that year was exported to China for processing, allowing one country to control >80% of the global REO production.

Of the fifteen rare earth elements (REEs) in the lanthanide series, heavier elements are in greater demand than the lighter ones and hence command substantially higher prices. The major sources of the heavy rare earth elements (HREEs) are ion adsorption clay (IAC) ores assaying typically 0.05-0.3% REEs, which are found in the regolith formed from weathering of granites. Despite their low grades, processing IACs is attractive due to the low mining and extraction costs. Approximately 40-90% of the REEs present in these ores are found in adsorbed forms rather than covalently bonded to anions; therefore, they can be more readily extracted by simple ion-exchange mechanisms rather than breaking strong chemical bonds under aggressive conditions as is the case with extracting REEs from the traditional rare earth minerals (REMs), e.g., bastnaesite, monazite, and xenotimes. Furthermore, higher proportions of the REEs in IACs are HREEs as compared to those in REMs. For these reasons, practically all the world's HREEs are produced from the IAC ores mined in South China (Yang et al., 2013). Thus, it would be desirable to develop efficient processes to extract REEs from clayey materials in the U.S. and other regions around the world.

### SUMMARY

Described herein are methods of extracting rare earth elements (REEs) from REE sources composed of or comprising clayey materials. In one aspect, the rare earth element source is waste materials generated in the coal and kaolin industries during the courses of upgrading mined coal and kaolin clays. The methods described herein generally involve (i) producing preconcentrates using physical separation methods and (ii) extracting REES and other critical materials from higher-grade preconcentrates using chemical extraction methods. Since physical separation methods are of substantially lower costs, the methods described herein can greatly reduce the overall costs, including both capital and operating costs, and also minimize environmental impacts.

The advantages of the present disclosure will be set forth in part in the description which follows, and in part will be obvious from the description or may be learned by practice of the aspects described below. The advantages described below will be realized and attained by means of the elements and combinations particularly pointed out in the appended claims. It is to be understood that both the foregoing general description and the following detailed description are exemplary and explanatory only and is not restrictive.

### BRIEF DESCRIPTION OF THE DRAWINGS

The accompanying drawings, which are incorporated in and constitute a part of this specification, illustrate several aspects described below:

FIG. 1 shows an exemplary process described herein to improve the extraction of rare earth elements (REEs) from coal byproducts.

FIG. 2 shows an exemplary process described herein for extracting REEs from the waste materials generated from the kaolin industry.

FIG. 3 compares the REE recoveries obtained by blunging and by fine grinding from the clayey materials isolated from a coal byproduct.

FIG. 4 compares the REE recoveries via pre-concentration by using exemplary flotation and HHS processes.

FIG. 5 shows the effect of NaOH concentration on total REE recoveries using the exemplary ammonium sulfate and HCl leaching processes described herein.

FIG. 6 shows the element-by-element recoveries from a pre-concentrate assaying 8,868.4 ppm TREE using different amounts of NaOH as an activator at 80° C. and using 0.5 M (NH4)2SO4 as a lixiviant in an exemplary process described herein.

FIG. 7 shows the results obtained from a 9,148 ppm TREE pre-concentrate obtained from a kaolin clay waste using a two-step leaching process, in which LREEs are extracted first by NaOH activation followed by (NH4)2SO4 leaching before extracting HREEs by acid baking followed by water leaching in an exemplary process described herein.

FIG. 8 shows the effects of solids content on the REE recovery and the REE concentration in an exemplary process described herein.

FIG. 9 shows the effect of sulfuric acid concentration on the REE and titanium recoveries at different concentrations of sulfuric acid in an exemplary process described herein.

FIG. 10 shows an exemplary two-step process of extracting LREEs by NaOH/HCl leaching followed by an H₂SO₄/H₂O leaching to extract HREEs with TiO₂ as a byproduct.

### DETAILED DESCRIPTION

Many modifications and other embodiments disclosed herein will come to mind to one skilled in the art to which the disclosed compositions and methods pertain to having the benefit of the teachings presented in the foregoing descriptions and the associated drawings. Therefore, it is to be understood that the disclosures are not limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred, in any respect. This holds for any possible non-express basis for interpretation, including matters of logic with respect to the arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a rare earth element” includes, but is not limited to, mixtures or combinations of two or more such elements.

It should be noted that ratios, concentrations, amounts, and other numerical data can be expressed herein in a range format. It will be further understood that the endpoints of each of the ranges are significant both in relation to the other endpoint and independently of the other endpoint. It is also understood that there are a number of values disclosed herein and that each value is also herein disclosed as “about” that particular value in addition to the value itself. For example, if the value “10” is disclosed, then “about 10” is also disclosed. Ranges can be expressed herein as from “about” one particular value and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “rare earth element” is defined as any element that includes one or more of the 15 lanthanide elements, scandium or yttrium. The 17 rare-earth elements are cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), and yttrium (Y). They are often found in minerals with thorium (Th), and uranium (U). Rare earth elements generally exist as minerals in nature. In one aspect, the rare earth element is a rare earth phosphate, formate, carbonate, chloride, oxide, or hydroxide.

As used herein, the term “light rare earth elements” is defined the elements from lanthanum to gadolinium (57 to 64).

As used herein, the term “heavy rare earth elements” is defined the elements from terbium to lutetium (65 to 71).

As used herein, the term “admixing” is defined as mixing two or more components together so that there is no chemical reaction or physical interaction. The term “admixing” also includes the chemical reaction or physical interaction between two or more components.

The term “alkyl” as used herein is a branched or unbranched saturated hydrocarbon group of 1 to 24 carbon atoms, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dodecyl, tetradecyl, hexadecyl, eicosyl, tetracosyl, and the like. The alkyl group can be cyclic or acyclic. The alkyl group can be branched or unbranched. The alkyl group can also be substituted or unsubstituted. For example, the alkyl group can be substituted with one or more groups including, but not limited to, alkyl, cycloalkyl, alkoxy, amino, ether, halide, hydroxy, nitro, silyl, sulfo-oxo, or thiol, as described herein. A “lower alkyl” group is an alkyl group containing from one to six (e.g., from one to four) carbon atoms. The term alkyl group can also be a C1 alkyl, C1-C2 alkyl, C1-C3 alkyl, C1-C4 alkyl, C1-C5 alkyl, C1-C6 alkyl, C1-C7 alkyl, C1-C8 alkyl, C1-C9 alkyl, C1-C10 alkyl, and the like up to and including a C1-C24 alkyl.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” or “haloalkyl” specifically refers to an alkyl group that is substituted with one or more halide, e.g., fluorine, chlorine, bromine, or iodine. Alternatively, the term “monohaloalkyl” specifically refers to an alkyl group that is substituted with a single halide, e.g. fluorine, chlorine, bromine, or iodine. The term “polyhaloalkyl” specifically refers to an alkyl group that is independently substituted with two or more halides, i.e. each halide substituent need not be the same halide as another halide substituent, nor do the multiple instances of a halide substituent need to be on the same carbon. The term “alkoxyalkyl” specifically refers to an alkyl group that is substituted with one or more alkoxy groups, as described below. The term “aminoalkyl” specifically refers to an alkyl group that is substituted with one or more amino groups. The term “hydroxyalkyl” specifically refers to an alkyl group that is substituted with one or more hydroxy groups. When “alkyl” is used in one instance and a specific term such as “hydroxyalkyl” is used in another, it is not meant to imply that the term “alkyl” does not also refer to specific terms such as “hydroxyalkyl” and the like.

The term “aryl” as used herein is a group that contains any carbon-based aromatic group including, but not limited to, benzene, naphthalene, phenyl, biphenyl, anthracene, and the like. The aryl group can be substituted or unsubstituted. The aryl group can be substituted with one or more groups including, but not limited to, alkyl, cycloalkyl, alkoxy, alkenyl, cycloalkenyl, alkynyl, cycloalkynyl, aryl, heteroaryl, aldehyde, —NH₂, carboxylic acid, ester, ether, halide, hydroxy, ketone, azide, nitro, silyl, sulfo-oxo, or thiol as described herein. The term “biaryl” is a specific type of aryl group and is included in the definition of “aryl.” In addition, the aryl group can be a single ring structure or comprise multiple ring structures that are either fused ring structures or attached via one or more bridging groups such as a carbon-carbon bond. For example, biaryl to two aryl groups that are bound together via a fused ring structure, as in naphthalene, or are attached via one or more carbon-carbon bonds, as in biphenyl. Fused aryl groups including, but not limited to, indene and naphthalene groups are also contemplated.

The term “alkylaryl” as used herein is an alkyl group as defined herein substituted with one or more aryl groups as defined herein.

The term “enrich” as used herein is an increase in the amount or concentration of one or more rare earth elements in a final composition relative to a precursor composition. For example, the preconcentrates produced herein have a higher or greater concentration of rare earth elements relative to the clayey starting material.

As used herein, the terms “optional” or “optionally” means that the subsequently described event or circumstance can or cannot occur and that the description includes instances where said event or circumstance occurs and instances where it does not.

Unless otherwise specified, temperatures referred to herein are based on atmospheric pressure (i.e. one atmosphere).

Described herein are methods for extracting earth elements from rare earth element sources. The methods described herein provide a low-cost, environmentally benign process for extracting rare earth elements from rare earth element sources. Details for performing the methods described herein are provided below.

### Rare Earth Element Sources

In one aspect, the rare earth element source is a clayey material, including an ion adsorption clay (IAC). IAC ores are formed as a result of the in situ weathering of rare earth-rich host rocks such as granite. Clay minerals (e.g., kaolinite, halloysite, etc.) are made of layers of SiO₄ tetrahedra and AlO₄(OH)₂ octahedra. During the process of forming these minerals, part of the Si⁴⁺ and Al³⁺ ions in the cross-linked polyhedra are isomorphically substituted by cations of lower formal charges (e.g., Si⁴⁺ by Al³⁺ and Al³⁺ by Mg²⁺ ions, respectively), causing the basal surfaces of clay minerals to acquire net negative charges when they are contacted with water. The surface charge density (o) of kaolinite samples has been determined to be 0.19-0.24 C/m³, depending on their origins. The surface charges of such origins are referred to as structural (or permanent) charges to be distinguished from the pH-dependent surface charges. The latter surface charges are created due to the adsorption of H⁺ or OH⁻ ions on the silanol (Si—OH) or aluminol (Al—OH) groups exposed on the edge surfaces of clay minerals. The Ln³⁺ ions released from weathering of rare earth minerals (REMs) originally present in granite would adsorb on the surface of kaolinite, which is also formed by weathering of granite. Heavy rare earth elements (HREEs) have smaller ionic radii than the light rare earth elements (LREEs) due to lanthanide contraction and hence are more strongly adsorbed on kaolinite, which makes it more difficult to remove the former than the latter.

The Ln³⁺ ions adsorbed on the kaolinite surfaces are most commonly extracted into solution via the ion-exchange mechanism depicted as follows,

$$Clay - {Ln}^{3 +} + 3 {NH}_{{4}^{+}} \to Clay - 3 {NH}_{{4}^{+}} + L {n}^{3 +} \qquad ( 1 )$$

in which one mole of lanthanide ions (Ln³⁺) is displaced by three moles of ammonium ions to keep the charge balance. The kinetics of this reaction is fast as the REE ions are mostly attracted to the negatively charged basal surfaces of clay minerals by coulombic attraction, which is weaker than the covalent bonding by orders of magnitudes. It has been shown that Ln³⁺ ions are weakly adsorbed on the basal surfaces of kaolinite as outer-sphere hydrated complexes with 8-9 water molecules, while some of the Ln³⁺ ions adsorb on the edge surfaces as inner-sphere complexes via bridging oxygens. The former species are attracted to the surface via weak electrostatic force owing to the large effective ionic radii; therefore, they can be readily displaced by NH₄⁺ ions as depicted in Eq. [1]. The latter species are effectively chemisorbed, which makes it difficult to be removed via the ion-exchange mechanism, particularly at a high pH (Borst et al., 2020). Mukai et al. (2020) studied the extraction of Ln³⁺ ions using (NH₄)₂SO₄ as lixiviant and found that HREEs are more difficult to be extracted from IACs than the LREEs (Borst et al., 2020). This finding can be attributed to the decrease in ionic radii of the Ln³⁺ ions with increasing atomic number and hence the stronger electrostatic attraction to the basal surfaces of clay minerals.

It had been a general belief that IAC deposits are formed under humid and warm climates under subtropical weather conditions (Papangelakis and Moldoveanu, 2014). Recent studies conducted by USGS showed, however, that both the climate and geological conditions in the eastern U.S. were conducive to forming regolith-hosted IAC deposits in the granite plutons in Central Appalachia (Foley and Ayuso, 2015). It has been reported that the REE grades of the IAC samples taken in Stewartsville, Virginia, are comparable to those found in Heling, South China. The authors showed that 30-52% of the LREEs and 30-73% HREEs were extracted using Na-acetate and Na-pyrophosphate, respectively.

Bryan et al. (2015) suggested that coal deposits are generally formed in a basin that may also contain REE-enriched sediments from the deposition and/or erosion of volcanic, intrusive, and detrital resources. Thus, the clayey materials formed in granite rocks may have been an integral part of coal formation. Recognizing that ˜80% of the mineral matter in coal has been derived from kaolinite, illite, halloysite, and other clay minerals, it would be reasonable to explore the possibility of extracting REEs from the coal byproducts such as underclay and thickener underflows. Many investigators reported, however, that it is more difficult to extract REEs from the clayey materials isolated from coal byproducts than from the IACs mined in China and on the Appalachian Mountains in the U.S.

Kaolin clay is formed by weathering of granite as follows,

$$2 KA l {Si}_{3} {O}_{8} + 2 {CO}_{2} + {H}_{2} O \to A {l}_{2} {Si}_{2} {{O}_{5} ( OH )}_{4} + 4 {KHCO}_{3} + 4 {SiO}_{2} \qquad ( 2 )$$

in which potassium feldspar reacts with the CO₂ dissolved in meteoric water to produce kaolinite. Other components of granite, e.g., muscovite and biotite, can also become different clay minerals by chemical weathering. The clay minerals formed in this manner will serve as hosts for the REEs released from weathered REMs and become IACs.

Part of the IACs formed in the Appalachian Mountains will be transported by the rainwater along the western and eastern slopes of the mountains, forming different detrital REE resources. The IACs transported to the coal basins of West Virginia, for example, will become the ash-forming minerals incorporated into coal seams, overburdens, and shales, while those transported to the eastern coastal planes will form kaolinite deposits. The former is located deep underground, while the latter is located near the surface. Therefore, the IACs and associated minerals continue to weather, forming secondary REE-bearing minerals.

The IACs transported to coal basins may be passivated as follows,

$$Clay - {Ln}^{3 +} + {PO}_{4}^{3 -} \to Clay - {LnPO}_{4} ( s ) \qquad ( 3 )$$

in which the PO₄³⁻ ions in water react with the Ln³⁺ ions adsorbed on clay surfaces to form a lanthanide phosphate (LnPO₄), which is difficult to be extracted into solution via the simple ion-exchange leaching mechanism represented by Reaction [1]. The most likely source of the phosphate ions in water may be apatite (Ca₁₀(PO₄)₆(OH)₂), which is sparingly soluble. Furthermore, the conditions under which coal was formed would provide reducing conditions deep underground, which would not be conducive to weathering REE-bearing minerals.

The IACs transported to the eastern coastal planes, on the other hand, continued to weather and became secondary REMs, e.g., crandallite ((Ca(Al,Ln)₃(PO₄)₂(OH)₅H₂O), rhabdophane (Ln,Ca,Th)(PO₄)·H₂O, and others. It is well-documented that crandallite is a weathering product of kaolinite and apatite (Viellard et al., 1979). Both the Al³⁺ and Ca²⁺ ions in crandallite originated from weathered kaolinite and apatite, respectively. For example, microscopic examinations of the clayey materials taken from the waste products from the Georgia kaolin industry showed large amounts of crandallite. Conversely, much less crandallite was found in coal byproducts.

A significance of these findings is that REE-bearing minerals, which include passivated IACs, and the secondary and some of the residual primary REMs, can be separated using physical separation methods as described herein from the barren minerals containing practically no REEs and to obtain preconcentrates. For example, physical separation, e.g., flotation, oil agglomeration, two-liquid flotation (TLF), hydrophobic-hydrophilic separation (HHS), etc., are of substantially lower costs than chemical separation, e.g., acid and alkali leaching. As discussed herein, using a preconcentrate as a feedstock to a chemical separation process would greatly reduce both the capital and operating costs. According to Viellard et al. (1979), crandallite is less stable than apatite, which in turn, is less stable than monazite. As discovered herein, preconcentrates composed mainly of unstable crandallite provide a distinct advantage of preconcentrating REE-bearing materials prior to chemical extraction. It has been unexpectedly discovered that it is easier to extract REEs from the rare earth resources present in kaolin deposits in coastal planes of Georgian and around the World.

In one aspect, described herein are the methods of recovering rare earth elements (REEs) from the clayey materials associated with coal and coal byproducts and kaolinite ores. In another aspect, the clayey materials are IACs and the associated secondary phosphate minerals found in the kaolin clays mined in coastal plains.

Coal byproducts include clayey materials with REEs adsorbed to them. There are many advantages of extracting REEs from the clay minerals present in coal refuse. First, most of the REEs in coal is associated with clay minerals (Bryan et al., 2015). Second, Ln³⁺ ions are likely adsorbed on clay surfaces by the weak coulombic attractions or electrical double-layer (EDL) forces; therefore, less energy is required to recover them by ion-exchange leaching than by using strong acids to break chemical bonds. Third, clay minerals constitute 60-70% of the mineral matter in coal (Renton et al., 1979). Fourth, clay minerals congregate to thickeners in coal cleaning plants, obviating the need for re-mining. Fifth, the amounts of REEs that can be recovered from currently operating coal cleaning plants may exceed 50% of the domestic consumption. Sixth, the REEs extracted from clay are rich in HREEs and energy-critical materials. Seventh, the amounts of radioactive elements, i.e., Th and U, are low. Eighth, the clay minerals are rich sources of yttrium (Y) and scandium (Sc) that command high prices. Ninth, the ion-exchange leaching process does not entail substantial dissolution of clayey materials, which will minimize the cost of effluent treatment. Tenth, processing thickener underflows will produce salable coal as byproducts. Finally, the reject materials in the coal recovery step can be used as feedstocks using a low-cost physical separation process to obtain high-grade REM concentrates with high contained values that can be used as feedstocks for producing rare earth oxides and metals using the acid- or alkali-cracking and leaching processes that are more costly than the simple ion-exchange leaching processes employed in South China.

### Preconcentration

The REE grades in clayey resources are usually in the range of 300 to 600 ppm in the U.S. Therefore, increasing the grade of REEs by preconcentration is the first step of the methods described herein. In one aspect, preconcentration generally involves a physical separation process in which a rare earth element source is upgraded to obtain a feedstock containing substantially higher concentrations of REEs. In one aspect, a rare earth element source is subjected to the hydrophobic, hydrophilic separation (HHS) process to increase the concentrations of REEs by eliminating the barren minerals containing little or no REEs from the rare earth element source and thereby reduce the volume of the feedstock to the chemical extraction processes that are costlier than physical separation methods. Also, chemical extraction processes can generate significant amounts of toxic waste. The hydrophobic-hydrophilic separation (HHS) process is described in detail in U.S. Pat. No. 9,518,241, which is incorporated by reference in its entirety.

The HHS process is a method of separating fine particles with practically no lower particle size limit. The recovery of ultrafine particles as used in the methods described herein is important for the recovery of rare earth minerals from various resources, as these minerals are usually finer than 10 microns. In the HHS process, REE-bearing minerals are selectively hydrophobized by adsorbing appropriate hydrophobizing agent, e.g., potassium octyl hydroxamate, on the surface so that the ultrafine mineral particles can be collected by the droplets of hydrophobic liquid (or oil). Light hydrocarbon oils with low boiling points and low heats of vaporization are used so that they can be recovered and recycled at low costs.

The HHS process can also remove the process water recovered by the entrainment and/or entrapment mechanisms by breaking the water-in-oil emulsions stabilized by hydrophobic particles. As the water is removed, small hydrophilic particles (usually impurities) dispersed in the aqueous phase are also removed. Thus, the HHS process is capable of producing high-grade preconcentrates that are substantially free of surface moisture.

In another aspect, an REE source can be subjected to flotation to separate one or more REE-bearing minerals from REE sources to produce preconcentrates. In this process, REE-bearing minerals are hydrophobized by adsorbing appropriate reagents known as collectors in the same manner as described for the HHS process. The hydrophobized particles are then collected by air bubbles rather than recyclable oil drops.

In one aspect, hydrophobizing reagents are selected from alkyl hydroxamate, aryl hydroxamate, hydroxamic acid, cationic surfactant, anionic surfactant, fatty acids, non-ionic surfactant, or any combination thereof. In one aspect, the hydrophobizing reagent is one or more compounds having the formula

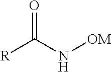

where R is an alkyl, aryl, or alkylaryl group having 4-28, and preferably 6-24 carbon atoms, and M represents an alkali metal, an alkaline earth metal or hydrogen.

In one aspect, compounds having the formula given above are effective for the flotation of titaniferous impurities from a variety of kaolin clays, including those having creamy, reddish and tan discoloration. In another aspect, the hydrophobizing reagent is octylhydroxamic acid or a salt thereof (e.g., sodium or potassium). The hydrophobizing reagents described in U.S. Pat. No. 4,629,556, which is incorporated by reference in its entirety, can be used in the flotation processes described herein.

In another aspect, a clayey REE source is subjected to dispersion of fine particulate materials from each other, which is also referred to as blunging. Dispersion is a low-cost method of physically detaching (or liberating) REE-bearing particulate materials from barren mineral particles with little or no REEs. The REE-bearing minerals may include IACs, primary and secondary REE phosphates, and other REMs. For blunging, different types of polyelectrolytes are used to increase the surface charges of the particles suspended in an aqueous media. The role of polyelectrolytes is to increase the surface charges of the particulate materials and hence increase the disjoining pressure of the thin liquid films (TLFs) of water confined between two surfaces. The dispersion (or blunging) step precedes the physical separation step, e.g., HHS and flotation, to obtain high-grade preconcentrates. An alternative to blunging is fine grinding, which is costly when the size of the particles is in microns.

### Chemical Extraction

The preconcentrates produced as described above are subjected to a chemical leaching step to extract REEs into solution. The extraction methods described herein provide low-cost and environmentally benign processes for extracting REEs from preconcentrates. A general approach involves converting the REEs that are in insoluble forms to readily extractable forms prior to leaching.

In the first step, a preconcentrate of rare earth resource that may be in insoluble forms as depicted by Reaction [1] are treated with a base to convert the passivated form to an activated form. In one aspect, the passivated forms include rare earth phosphates, while the activated forms include rare earth oxides, hydroxides and/or oxyhydroxides. The activation step may involve displacement of the PO₄³⁻ ions by a stronger base such as OH ions. In one aspect, the base comprises an alkali metal hydroxide, ammonium hydroxide, or a combination thereof. In another aspect, the base comprises sodium hydroxide, potassium hydroxide, sodium carbonate, lime, or any combination thereof.

In one aspect, the base is an aqueous composition when admixed with the preconcentrate. In another aspect, aqueous base composition is admixed with an aqueous composition composed of the preconcentrate. The amount of base used can vary depending upon the amount of rare earth element adsorbed on the preconcentrate. In one aspect, the base is from about 1% to about 80% by volume of the first composition. In another aspect, the concentration of the base can vary. In one aspect, the concentration of the base can be from about 0.1 M to 5 M.

In addition to the base (or alkali) treatment, the preconcentrate is contacted with an electrolyte composition to extract rare earth elements from the preconcentrate. Not wishing to be bound by theory, the electrolyte solution containing the cations and/or anions can readily destabilize and decompose the preconcentrate source to allow for rare earth elements to be extracted from the preconcentrate. The use of the electrolyte solution in combination with the base enhances the decomposition and the subsequent removal of the rare earth elements from the preconcentrate. For example, lower amounts of the base are required when used in combination with the electrolyte composition, which ultimately reduces the cost of the extraction process. The electrolyte source includes chelating agents and/or complexing agents.

After a base treatment, an electrolyte is added next to the composition. In one aspect, the electrolyte composition comprises a plurality of cations, anions, or a combination thereof. In one aspect, the electrolyte composition includes cations such as, for example, ammonium ions, aluminum ions, magnesium ions, sodium ions, cadmium ions, or any combination thereof. In another aspect, the electrolyte composition includes anions such as, for example, sulfate ions, formate ions, bicarbonate ions, carbonate ions, chloride ions, nitrate ions, pyrophosphate, or any combination thereof. In another aspect, the electrolyte composition includes ammonium sulfate, aluminum sulfate, magnesium sulfate, sodium chloride, sodium acetate, sodium pyrophosphate, sodium bicarbonate, ammonium formate, ammonium nitrate, or any combination thereof.

In one aspect, the electrolyte composition comprises a chelating agent. A chelating agent is any molecule that forms two or more coordination bonds with the rare earth element. For example, the chelating agent can be an organic molecule with two amine groups, where each amine group can form a coordination bond with a rare earth ion (e.g., a lanthanide ion Ln³⁺). In one aspect, the chelating agent can be a bidentate ligand, a tridentate ligand, a tetradentate ligand, a pentadentate ligand, a hexadentate, or an octadentate ligand.

In one aspect, the electrolyte composition comprises a complexing agent. Complexing agents bind with the lanthanide ions in solution and thereby decrease the activities of the ions, causing the solubility of a rare earth resource in water to increase. In one aspect, the complexing agent is a Lewis base or a Bronsted base. Examples of complexing agent include, but are not limited to, amines (e.g., primary, secondary, or tertiary) and anions such as, for example, acetate ions, sulfate ions, formate ions, bicarbonate ions, carbonate ions, chloride ions, nitrate ions, pyrophosphate, or any combination thereof.

In one aspect, when the electrolyte composition is added to the preconcentrate, the pH of the final composition can be in the range of about 3.0 to about 10.

After a preconcentrate has been admixed with a base and electrolyte composition such that the rare earth element source has been destabilized and/or decomposed, the preconcentrate can release rare earth element into solution by the addition of an appropriate lixiviant and be subsequently isolated from the composition. In one aspect, the rare earth element can be isolated from the solution as precipitates from the composition by the addition of a precipitating agent.

Depending upon the preconcentrate and the condition used in the methods described herein, the isolated rare earth element can be one or more of different compounds. In one aspect, the rare earth element that is isolated comprises a rare earth element metal ionic compound. In another aspect, the rare earth element that is isolated comprises a rare earth element salt, a rare earth element hydroxide, a rare earth element oxide, or a combination thereof.

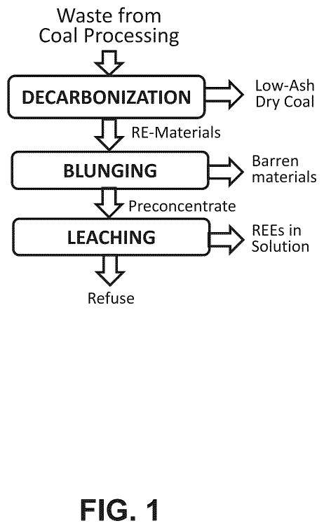

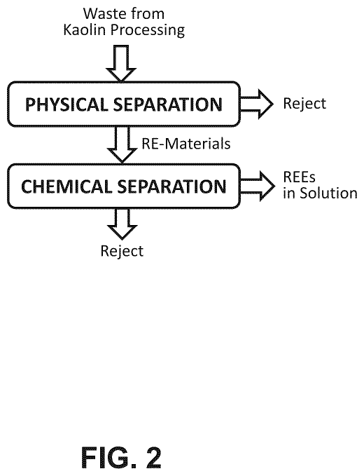

FIGS. 1 and 2 provide exemplary reaction schemes for performing the methods described above.

In another aspect, the methods described herein are efficient in removing heavy rare earth elements (HREEs) from clayey materials. Not wishing to be bound by theory, although much of the rare earth elements in clay materials are present as IACs and secondary phosphate minerals, a significant amount of the primary rare earth phosphate such as xenotime, which is the best source of HREEs, is also present. Here, the stability of HREEs arises from their small ionic radii.

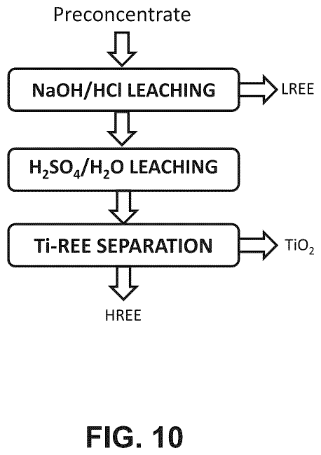

In one aspect, rare earth elements including HREEs are removed with the use of sulfuric acid. An example of this is provided in FIG. 10. After the preconcentrate has been treated with a base, an electrolyte (HCl) is added to extract mainly LREEs. The residue is then treated with sulfuric acid to extract HREEs. The composition enriched with HREEs is subsequently treated to remove TiO₂.

In another aspect, rare earth elements are removed from a preconcentrate produced herein with the use of phosphate-solubilizing microorganisms. In one aspect, after the pre-concentrate is treated with a base, the resulting composition is treated with a phosphate-solubilizing microorganism. In one aspect, the composition is incubated with the phosphate-solubilizing microorganism. In one aspect, the phosphate-solubilizing microorganism comprises eubacteria, archaea, algae, and a fungus. In another aspect, the phosphate-solubilizing microorganism is from the genus Pseudomonas, Bacillus, Micrococcus, Aspergillus, or Fusarium. In another aspect, the phosphate solubilizing microorganism is a bacteria comprising Atrophaeus, Paenibacillus macerans, Vibrio proteolyticus, Xanthobacter agilis, Pantoea aananatis, P. putida, Brevibacillus agri, B. subtilis, or Bacillus megaterium.

### Aspects

Aspect 1. A method of extracting one or more rare earth elements (REEs) from a clayey REE source comprising the steps of
a) subjecting the REE source to high-shear agitation in the presence of a polyelectrolyte to liberate REE-bearing minerals from the REE source;
b) separating the liberated REE-bearing minerals by a physical separation method to obtain a preconcentrate enriched with REE; and
c) extracting REEs from the preconcentrate by a chemical extraction method.

Aspect 2. The method of Aspect 1, wherein the clayey REE source comprises kaolinite.

Aspect 3. The method of Aspect 1, wherein the clayey REE source comprises detrital kaolin clays deposited on a coastal plane.

Aspect 4. The method of any one of Aspects 1-3, wherein the clayey REE source further comprises a secondary rare earth minerals (e.g., crandallite, rhabdophane), residual primary rare earth minerals, or a combination thereof.

Aspect 5. The method of any one of Aspects 1-4, wherein the clayey REE source is present in a coal byproduct.

Aspect 6. The method of any one of Aspects 1-5, wherein the polyelectrolyte in step a) is sodium silicate, polyacrylate, a polyphosphate, or any combination thereof.

Aspect 7. The method of any one of Aspects 1-6, wherein the physical separation method comprises flotation, hydrophobic-hydrophilic separation (HHS), or a combination thereof.

Aspect 8. The method of Aspect 7, wherein the physical separation method recovers particles less than 30 microns in diameter, or particles having a diameter from 1 micron to less than 30 microns.

Aspect 9. The method of Aspect 7, wherein the flotation and HHS processes comprises rendering the REE-bearing minerals hydrophobic using one or more hydrophobizing agents.

Aspect 10. The method of Aspect 9, wherein the hydrophobizing agent is selected from alkyl and/or aryl hydroxamates and hydroxamic acids, cationic surfactant, anionic surfactant, fatty acids, non-ionic surfactant, or any combination thereof.

Aspect 11. The method of any one of Aspects 1-10, wherein steps a) and b) comprises
a) agitating an aqueous slurry comprising the REE source under conditions of high-shear agitation in the presence of a polyelectrolyte to liberate the REE-bearing materials from other particulate materials;
b) adding a first hydrophobic liquid to form agglomerates of the hydrophobic particulate materials;
c) separating the agglomerates from the aqueous liquid;
d) dispersing the agglomerates in a second hydrophobic liquid, during the course of which the water droplets trapped inside the agglomerates during the agglomeration step are liberated from the hydrophobic REE-bearing materials and fall out of the hydrophobic liquid along with the hydrophilic gangue minerals containing practically no REEs; and
   thereby obtaining a higher-grade REE-bearing preconcentrate in the hydrophobic liquid phase.

Aspect 12. The method of Aspect 11, wherein said first or second hydrophobic liquid comprises an n-alkane, an n-alkene, an unbranched and branched cycloalkane and cycloalkene, ligroin, naphtha, petroleum naptha, petroleum ether, liquid carbon dioxide, or any combination thereof.

Aspect 13. The method of Aspect 11, wherein said first or second hydrophobic liquid comprises gasoline, kerosene, diesel fuel, heating oil, or any combination thereof.

Aspect 14. The method of Aspect 11, wherein said first or second hydrophobic liquid comprises gasoline, kerosene, diesel fuel, heating oil, or any combination thereof.

Aspect 5. The method of any one of Aspects 1-14, wherein the preconcentrate is from about 50%, 100%, 200%, 300%, 400%, 500%, 600%, 700%, 800%, 900%, or 1,000%, greater than the amount of the rare earth elements present in the rare earth elements source, where any value can be a lower and upper endpoint of a range.

Aspect 16. The method of any one of Aspects 1-15, wherein the chemical extraction method comprises the steps of
a) admixing a preconcentrate with a base at a temperature less than or equal to 100° C. to displace the phosphate ions and produce REE oxides and hydroxides to produce a first composition, and
b) leaching the first composition by (i) acid leaching or (ii) by ion exchange leaching with an electrolyte as a lixiviant.

Aspect 17. The method of Aspect 16, wherein the base comprises an alkali metal and/or ammonium hydroxide.

Aspect 18. The method of Aspect 16, wherein the base comprises sodium hydroxide, potassium hydroxide, sodium carbonate, lime, or any combination thereof.

Aspect 19. The method of any one of Aspects 16-18, wherein the base is used at a concentration of about 1% to about 80% by volume, about 1% to about 50% by volume, about 1% to about 30% by volume, or about 1% to about 15% by volume.

Aspect 20. The method of any one of Aspects 16-20, wherein the preconcentrate is admixed with the base at a temperature less than or equal to 100° C., or about 20° C., 25° C., 30° C., 35° C., 40° C., 45° C., 50° C., 55° C., 60° C., 65° C., 70° C., 75° C., 80° C., 85° C., 90° C., 95° C., or 100° C., where any value can be a lower and upper end-point of a range.

Aspect 21. The method of any one of Aspects 16-20, wherein the acid leaching is conducted at concentrations in the range of 0.1 M to 5 M, or 0.1 M, 0.5 M, 1.5 M, 2.0 M, 2.5 M, 3.0 M, 3.5 M, 4.0 M, 4.5 M, or 5.0 M, where any value can be a lower and upper endpoint of a range.

Aspect 22. The method of Aspect 21, wherein the acid is hydrochloric acid.

Aspect 23. The method of any one of Aspects 16-20, wherein the electrolyte composition comprises ammonium ions, aluminum ions, magnesium ions, sodium ions, cadmium ions, and other cations of low hydration enthalpy, or any combination thereof.

Aspect 24. The method of any one of Aspects 16-20, wherein the electrolyte composition comprises sulfate ions, nitrate ions, formate ions, carbonate ions, bicarbonate ions, chloride ions, or any combination thereof.

Aspect 25. The method of any one of Aspects 16-20, wherein the electrolyte composition comprises ammonium sulfate, aluminum sulfate, magnesium sulfate, sodium chloride, ammonium formate, ammonium nitrate, and any other electrolyte that can form complexes with rare earth elements, or any combination thereof.

Aspect 26. The method of any one of Aspects 16-20, wherein the electrolyte composition is admixed with the first composition at a pH of from about 3.5 to about 10, or about 3.5, 4.0, 4.5, 5.0, 5.5, 6.0, 6.5, 7.0, 7.5, 8.0, 8.5, 9.0, 9.5 or 10, where any value can be a lower and upper endpoint of a range.

Aspect 27. The method of any one of Aspects 16-20, wherein the first composition is admixed with the electrolyte at a temperature less than or equal to 100° C., or about 40° C., 45° C., 50° C., 55° C., 60° C., 65° C., 70° C., 75° C., 80° C., 85° C., 90° C., 95° C., or less than 100° C., where any value can be a lower and upper endpoint of a range.

Aspect 28. The method of any one of Aspects 16-20, wherein the electrolyte is ammonium sulfate and is optionally used in combination with a chelating agent, a complex agent, or a combination thereof.

Aspect 29. The method of Aspect 28, wherein the chelating agent is selected from organic acid, diamine, polyamine, hydroxamic acid, polyol, dicarboxylic acid, and mixtures thereof.

Aspect 30. The method of Aspect 29, wherein the dicarboxylic acid is selected from maleic acid, succinic acid, glutamic acid, or any combination thereof.

Aspect 31. The method of Aspect 1, wherein a chelating agent is used in combination with a base in step (a).

Aspect 32. The method of Aspect 31, wherein the chelating agent is ethylenediamine-tetracetate (EDTA).

Aspect 33. The method of Aspect 31, wherein the complexing agent is selected from a sulfate, a formate, carboxylic acid, and any combination thereof.

Aspect 34. A method of extracting one or more rare earth elements (REEs) from a clayey REE source, comprising the steps of
a) subjecting the REE source to high-shear agitation in the presence of a polyelectrolyte to liberate REE-bearing minerals from the REE source;
b) separating the liberated REE-bearing minerals by a physical separation method to obtain a preconcentrate enriched with REE; and
c) treating the preconcentrate with a phosphate solubilizing microorganism.

Aspect 35. The method of Aspect 34, wherein the phosphate solubilizing microorganism is selected from bacteria comprising Atrophaeus, Paenibacillus macerans, Vibrio proteolyticus, Xanthobacter agilis, Pantoea aananatis, P. putida, Brevibacillus agri, B. subtilis, or Bacillus megaterium.

Aspect 36. The method of Aspect 34, wherein the phosphate solubilizing microorganism is selected from fungi comprising Aspergillus niger or Aspergillus terreus.

Aspect 37. A method of extracting one or more rare earth elements (REEs) from a clayey REE source comprising the steps of
a) subjecting the REE source to a physical separation process to obtain a enriched preconcentrate;
b) contacting the preconcentrate with sulfuric acid at a temperature above 150° C. to produce an acid-treated concentrate; and
c) contacting the acid-treated preconcentrate with water to extract both light and heavy rare earth elements into water to produce a leach liquor enriched with light and heavy rare earth elements.

Aspect 38. The method of Aspect 37, wherein the clayey REE source comprises anatase, wherein titanium ions and REE ions present in the leach liquor are separated from the leach liquor comprising the following steps:
a) adding a base to the leach liquor until the pH is raised to less than 5, wherein a precipitate comprising titanium dioxide is formed and a solution; and
b) separating the solution from the precipitate, wherein the solution is enriched with rare earth elements.

Aspect 39. A method of extracting one or more rare earth elements (REEs) from a clayey REE source comprising the steps of
a) subjecting the REE source to high-shear agitation in the presence of a polyelectrolyte to liberate REE-bearing minerals from the REE source;
b) separating the liberated REE-bearing minerals by a physical separation method to obtain a preconcentrate enriched with REE;
c) admixing a preconcentrate with a base at a temperature less than or equal to 100° C. to displace the phosphate ions and produce a first composition comprising REE oxides and hydroxides,
d) leaching the first composition by (i) acid leaching or (ii) by ion exchange leaching to produce a first leach liquor enriched with light rare earth elements and a leach residue;
e) contacting the leach residue with concentrated sulfuric acid at a temperature above 150° C. to produce an acid-treated product;
f) contacting the acid-treated product with water to obtain a second leach liquor comprising heavy rare earth elements and titanium ions; and
g) precipitating titanium dioxide by raising the pH to less than 5, leaving the second leach liquid enriched with heavy rare earth elements.

Aspect 40. The method of Aspect 39, wherein the clayey REE source comprises anatase, wherein titanium ions and REE ions present in the second leachant are separated from the second leachant comprising the following steps:
a) adding a base to the second leachant until the pH is raised to less than 5, wherein a precipitate comprising titanium dioxide is formed and a solution; and
b) separating the solution from the precipitate, wherein the solution is enriched with heavy rare earth elements.

Aspect 41. The method of Aspects 37-40, wherein the concentration of sulfuric acid is from about 10% to about 80% by volume, about 1% to about 50% by volume, about 1% to about 30% by volume, or about 1% to about 15% by volume.

Aspect 42. The method of Aspects 37-40, wherein step e) is conducted at a temperature from about 75° C. to about 350° C. from about 0.1 hours to 5 hours.

Aspect 43. The method of any one of Aspects 1-42, wherein the REE source is derived from the US coastal plans (Georgia, South Carolina, North Carolina, or Tennessee).

Aspect 44. The method of any one of Aspects 1-42, wherein the REE source is derived from China, Brazil, Germany, or the United Kingdom.

### EXAMPLES

The following examples are put forth so as to provide those of ordinary skill in the art with a complete disclosure and description of how the compounds, compositions, and methods described and claimed herein are made and evaluated, and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, the temperature is in ° C. or is at ambient temperature, and pressure is at or near atmospheric. Numerous variations and combinations of reaction conditions (e.g., component concentrations, desired solvents, solvent mixtures, temperatures, pressures, and other reaction ranges and conditions) can be used to further optimize the reagent consumption while at the same time increase the extraction efficiency.

### Example 1

In the U.S. coal industry, coal fines are cleaned of ash-forming minerals by flotation, which is efficient in a narrow particle size range of 44-150 μm. Furthermore, it is difficult to dewater the particles below the lower size limit. Therefore, the industry has been discarding the particles below 44 μm to thickeners before pumping the settled materials into impoundments. In general, 40-50% of the thickener underflows are coal and the rest is mineral matter, mostly clay.

In this example, a thickener underflow sample assaying 46.9% ash was subjected to laboratory-scale hydrophobic-hydrophilic separation (HHS) tests to recover the ultrafine coal first and recover the REE-bearing materials (which included REMs/IACs) from the reject. The clean coal product obtained from the first step assayed 3.5% ash and 2.94% moisture with a combustible recovery of 93.3%.

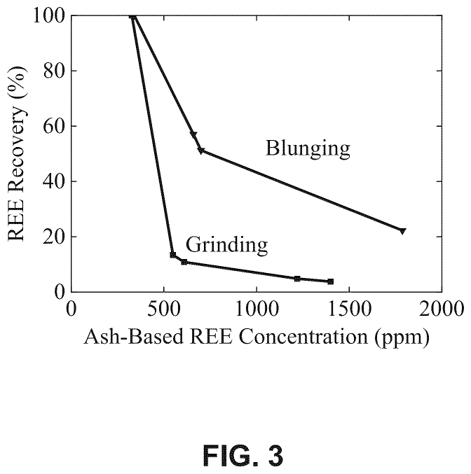

The reject material assaying 93.45% ash was then subjected to a second-stage HHS test to recover REEs. In this step, the reject material was pulverized in a stirred ball mill for 10 hours to liberate the REMs/IACs grains from the minerals bearing no REEs. The mill product was conditioned with 0.4 kg/t potassium octyl hydroxamate (KOH) for 10 min to render the REE-bearing minerals selectively hydrophobic prior to the second stage HHS tests. The results of the REM/IAC recovery tests are presented in FIG. 3. Although the REE grades were substantially higher than the feed, the recoveries were poor. The poor recoveries may be attributed to the incomplete liberation of the REM/IAC grains from the gangue materials.

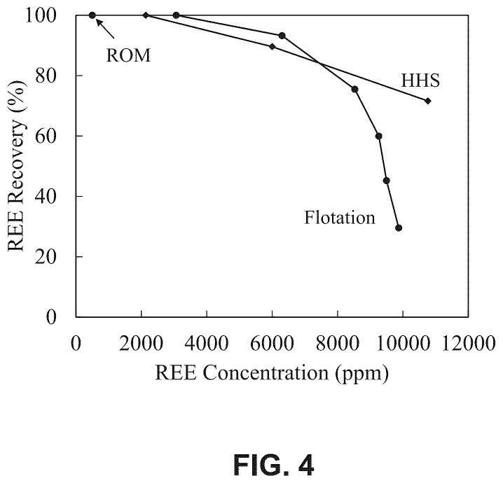

In another approach, the REM/IAC grains were liberated from gangue minerals by blunging, which is commonly used in the kaolin industry in Georgia and South Carolina to liberate anatase and other impurities from kaolinite particles in the presence of polyelectrolytes, e.g., sodium silicate, polyacrylate, and polyphosphate. The role of these reagents is to increase the electrical double-layer (EDL) potentials of the particles so that they can be fully dispersed. FIG. 4 shows the results obtained using ethylenediaminetetraacetic acid (EDTA) as a polyelectrolyte. As shown the results were far superior to those obtained by grinding, which is energy intensive.

### Example 2

The U.S. has the world's largest kaolin deposits in Georgia and South Carolina. The clay deposits have been formed due to weathering of the granite rocks on the Piedmont plateau. The kaolinite contents are in the range of 85-95%, the remainder being mainly quartz with minor amounts of mica, anatase, zircon, and iron oxides. These impurities particularly iron oxides and anatase that give brownish color to kaolin clay are removed by classification, magnetic separation, flotation, and selective flocculation. Flotation is efficient for removing anatase, which is the major discoloring impurity. In this process, hydroxamate collectors are used to hydrophobize anatase and remove the brownish mineral particles using air bubbles as prescribed by Yoon and Hildebrand (U.S. Pat. No. 4,629,556), with the waste materials (anatase) being discarded to a large impoundment.

As it turned out, the discoloring impurities removed as waste materials contain 1,800-2,000 ppm REEs, which is substantially higher than the crude clay, containing 400-500 ppm REEs, which is fed to flotation columns. This finding suggests that the hydroxamate collector for anatase, which is a chelating agent, also serves as a collector for REE-bearing minerals. Thus, one can use the waste materials generated from the flotation process as preconcentrates and thereby reduce the cost of extracting REEs as compared to the case of using crude clays directly as feedstocks for the chemical extraction process.

In this example, the waste materials (or preconcentrates) generated by flotation columns used in an industrial operation were further upgraded using two different physical separation processes, i.e., laboratory scale flotation and HHS processes, independently. In both sets of laboratory scale tests, 100 g/t of octyl hydroxamic acid (OHA) and small amounts of MIBC were used as collector and frother, respectively. The flotation test was conducted in a 1 L Denver flotation cell, while the HHS tests were conducted using a kitchen blender for agglomeration, followed by a step of dispersing the agglomerates in a recyclable oil (hexane). The results presented in FIG. 4 show that the REE concentrations were further increased to very high levels, suggesting that one can use the physical separation methods, i.e., flotation and HHs processes, to produce high-quality preconcentrates that can be used to substantially reduce the costs of extracting REEs from clayey REE resources.

In the minerals processing industry, a mined ore is pulverized to liberate a target mineral from other minerals prior to flotation or any other physical separation processes. In the kaolin industry, a mined ore is subjected to blunging, in which an aqueous slurry of the ore is intensely agitated at high solids contents in the presence of polyelectrolytes to impart the particulate materials highly negative charges (or zeta-potentials) so that the impurities are dispersed from target minerals. The governing theory in dispersion is the DLVO theory (1941, 1948), which considers the attractive van der Waals (vdW) and repulsive electrical double-layer (EDL) forces. Inventors of the instant invention calculated the pressure, known as disjoining pressure, to estimate the repulsive pressures in the thin liquid films (TLFs) of water confined between two flat charged surfaces. The results showed that the disjoining pressure increases substantially with decreasing film thickness. The calculations made at a surface potential of-90 mV, the disjoining pressure increased from 18.5, 27.1, and 27.9 atm as the film thickness decreases from 1.34, 0.4, and 0.2 nm, respectively. These pressures are large enough to induce dispersion, which serves as a basis for liberation via blunging.

### Example 3

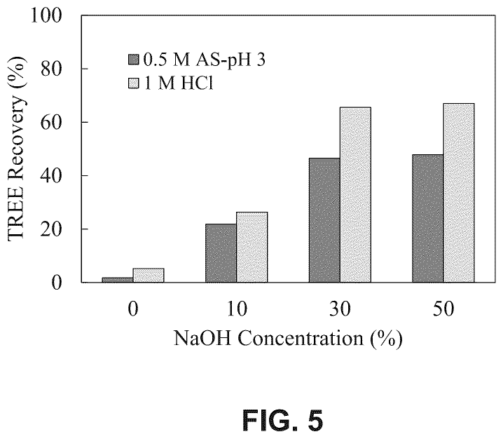

A flotation reject sample assaying 2,362.4 ppm REE was preconcentrated to 8,868.4 ppm REE by two stages of laboratory-scale flotation using 0.1 kg/t OHA as described in Example 2. The upgraded materials were contacted with NaOH solutions at 80° C. for 1 hr and leached for 1 hr using two different lixiviants, i.e., 0.5 M (NH₄)₂SO₄ and 1 M HCl, for comparison. The results presented in FIG. 5 show that REE recovery increased with increasing NaOH concentration, suggesting that the role of NaOH was one of activation. As has already been discussed, the IACs may have been passivated by the PO₄³⁻ ions in solution, which makes it difficult to be extracted by the ion-exchange mechanism represented by Reaction [1]. In the instant inventions, the PO₄³⁻ ions are displaced by OH ions, which is a stronger base. Once the LnPO₄ has been converted to Ln(OH)₃, the Ln³⁺ ions can be extracted into solution by the NH₄⁺ ions from solution via ion-exchange leaching as shown by Liu et al. (2022) or by acid leaching. The results presented in FIG. 5 shows that the latter was more efficient than the former as lixiviant. On the other hand, the ion exchange leaching at pH 3-4 is more sustainable. Note also that the NaOH concentration and temperature required for the activation are substantially lower than required for the traditional caustic leaching process. In the latter, monazite is decomposed in 70% NaOH solutions at >150° C. It has been shown that the PO₄³⁻ ions can also be displaced by using phosphate-solubilizing microorganisms.

That the REE-bearing materials are substantially extracted from the preconcentrates by the activation step suggests that the Ln(PO₄) formed on the kaolinite surface is less stable than monazite. Examination of the preconcentrates under SEM and TEM showed the presence of crandallite ((Ca(Al,Ln)₃(PO₄)₂(OH)₅H₂O), which appears to be substantially less stable than monazite according to the Eh-pH diagrams constructed from thermodynamic data. It appears that crandallite has been formed on kaolinite surfaces, in the vicinity of which the concentrations of Ln³⁺, Al³⁺, and Ca²⁺ ions may be high due to double-layer formation.

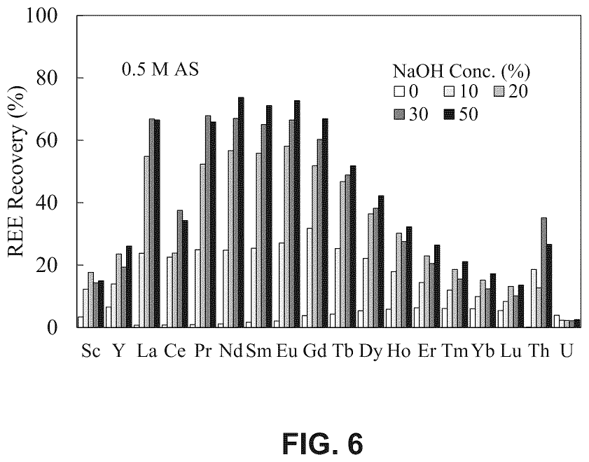

FIG. 6 shows the effect of NaOH concentration on the element-by-element recoveries obtained using (NH₄)₂SO₄ as lixiviant. As shown, the NaOH activation followed by ammonium sulfate leaching gave reasonable recoveries for LREEs but not for the HREEs, which may be attributed to the observation that the latter are harder acids and hence bind more strongly with a base such as PO₄³⁻ ions.

### Example 4

Although much of the REEs in clayey materials are present as IACs and secondary phosphate minerals, a significant amount of the primary REMs such as xenotime, which is the best source of HREEs, remain. In a sense, its resistance to weathering arises from the small ionic radii of REEs of high atomic weights. In this regard, it is not surprising that the mineral is decomposed under aggressive conditions using concentrated sulfuric acid and high concentrations of NaOH (Alex et al., 1998; Vijayalakshmi et al., 2001).

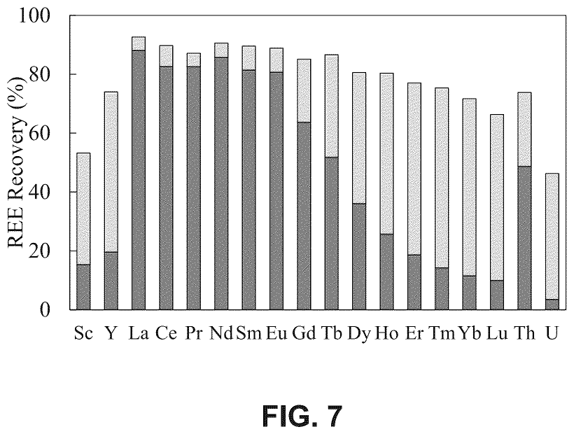

In this example, a Georgia kaolin clay was upgraded to 9,148 ppm REE by flotation, and the pre-concentrate was activated in a 30% NaOH solution for 1 hr and leached in a 1 M HCl solution. The residue was subsequently treated in a concentrated sulfuric acid solution for 1 hr at 300° C. The results presented in FIG. 7 show excellent results both in LREE and HREEs. It is anticipated that similar results can be obtained under milder conditions.

### Example 5

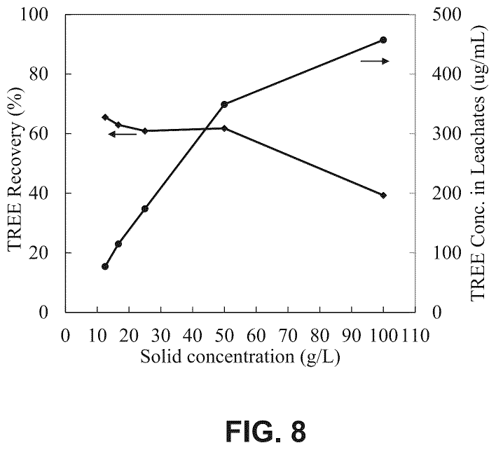

A Georgia kaolin sample was upgraded to 8,868 ppm REE by flotation and was activated in a 30% NaOH solution for 80° C. for 1 hr. The preconcentrated and activated sample was then leached in a 1 M HCl solution for 1 hr. The extraction tests were conducted at varying solid contents in the range of 10-100 g/L. As shown in FIG. 8, >60% REE recoveries were obtained until the solids content reached 50 g/L, above which the efficiency decreased. On the other hand, the REE concentration in the solution increased sharply at higher solids contents.

### Example 6

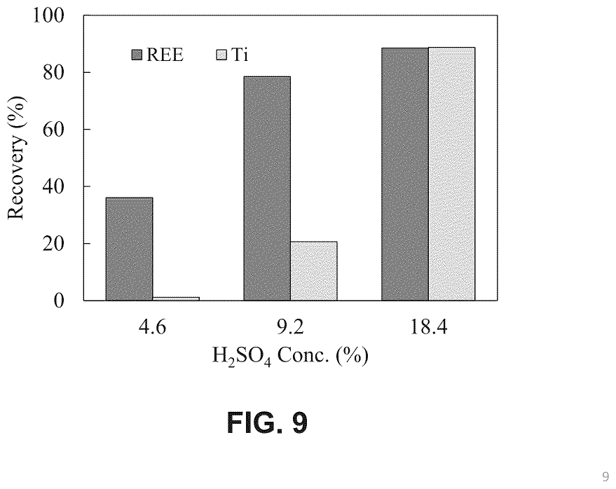

Kaolin clays mined in Georgia contain two major impurities: anatase (TiO₂) and iron oxides. The former contains a considerable amount of iron in its lattice, which gives a brownish tint to the clays. This mineral is, therefore, removed by froth flotation to produce coating-grade (bright) clays, while the latter impurities are removed by magnetic separation and chemical leaching. In the instant invention, anatase is removed by flotation using acetyl hydroxamate as a collector (hydrophobizing agent). It happens that this reagent also renders the REE-bearing minerals, including IACs and crandallite, co-present in kaolin clays hydrophobic as described in the preceding examples. Therefore, the preconcentrates obtained using the flotation or HHS process as feedstocks for the chemical extraction of REEs also contain large amounts of titanium, which is a critical mineral. It has been shown that titanium can be readily extracted into solution by sulfuric acid leaching. In general, extraction efficiencies increase with increasing acid concentration and temperature. The results presented in FIG. 9 were obtained at 18° C. after 1 hr of reaction time in a microwave oven.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

Alex, P., Suri, A. K. and Gupta, C. K., 1998. Processing of xenotime concentrate. Hydrometallurgy, 50 (3), pp. 331-338.
Borst, A. M., Smith, M. P., Finch, A. A., Estrade, G., Villanova-de-Benavent, C., Nason, P., . . . & Geraki, K. (2020). Adsorption of rare earth elements in regolith-hosted clay deposits. Nature communications, 11 (1), 1-15.
Bryan, R. C., Richers, D., Andersen, H. T., & Gray, T. (2015). Assessment of rare earth elemental contents in select United States coal basins. United States National Energy Technology Laboratory.
Derjaguin, B., & Landau, L. (1941). Theory of the stability of strongly charged lyophobic sols and of the adhesion of strongly charged particles in solutions of electrolytes. Acta Physico Chimica URSS, 14:633
Foley, N., & Ayuso, R. (2015a). REE enrichment in granite-derived regolith deposits of the Southeastern United States: prospective source rocks and accumulation processes. Geol. Surv. Pap, 3, 131-138.
Foley, N., Ayuso, R., Hubbard, B., Bern, C., & Shah, A. (2015b). Geochemical and mineralogical characteristics of REE in granitederived regolith of the Southeastern United States. In Mineral resources in a sustainable world. Proceedings of the 13th Biennial SGA Meeting (Vol. 2, pp. 725-729).
Liu, W., Feng, X., Noble, A., & Yoon, R. H. (2022). Ammonium sulfate leaching of NaOH-treated monazite. Minerals Engineering, 188, 107817.
Mukai, H., Kon, Y., Sanematsu, K., Takahashi, Y., & Ito, M. (2020). Microscopic analyses of weathered granite in ion-adsorption rare earth deposit of Jianxi Province, China. Scientific reports, 10 (1), 1-11.
Papangelakis, V. G., & Moldoveanu, G. (2014 September). Recovery of rare earth elements from clay minerals. In Proceedings of the 1st Rare Earth Resources Conference, Milos (pp. 191-202).
Renton, J. J., Cecil, C. B., Stanton, R., & Dulong, F. (1979). Compositional relationships of plants and peats from modern peat swamps in support of a chemical coal model. Carboniferous coal, short course and guidebook, 3, 57-102.
Sanematsu, K., Kon, Y., & Imai, A. (2015). Influence of phosphate on mobility and adsorption of REEs during weathering of granites in Thailand. Journal of Asian Earth Sciences, 111, 14-30.
USGS. (2021). Mineral Commodity Summary
Verwey, E. J. W., & Overbeek, J. Th. G. (1948), “Theory of the stability of lyophobic colloids”, The Journal of Physical and Colloid Chemistry, Amsterdam: Elsevier, 51 (3): 631
Vieillard, P., Tardy, Y., & Nahon, D. (1979). Stability fields of clays and aluminum phosphates; parageneses in lateritic weathering of argillaceous phosphatic sediments. American Mineralogist, 64 (5-6), 626-634.
Vijayalakshmi, R., Mishra, S. L., Singh, H. and Gupta, C. K., 2001. Processing of xenotime concentrate by sulphuric acid digestion and selective thorium precipitation for separation of rare earths. Hydrometallurgy, 61 (2), pp. 75-80.
Yoon, R. H. (2016). U.S. Pat. No. 9,518,241. Washington, DC: U.S. Patent and Trademark Office.
Yang, X. J., Lin, A., Li, X. L., Wu, Y., Zhou, W., & Chen, Z. (2013). China's ion-adsorption rare earth resources, mining consequences and preservation. Environmental Development, 8, 131-136.

1. A method of extracting one or more rare earth elements (REEs) from a clayey REE source comprising the steps of
subjecting the REE source to high-shear agitation in the presence of a polyelectrolyte to liberate REE-bearing minerals from the REE source;
a) separating the liberated REE-bearing minerals by a physical separation method to obtain a preconcentrate enriched with REEs; and
b) extracting REEs from the preconcentrate by a chemical extraction method.

2. The method of claim 1, wherein the clayey REE source comprises detrital kaolin clays deposited on a coastal plane.

3. The method of claim 2, wherein the clayey REE source further comprises a secondary rare earth mineral, residual primary rare earth minerals, or a combination thereof.

4. The method of claim 1, wherein the clayey REE source is present in a coal byproduct.

5. The method of claim 1, wherein the physical separation method comprises flotation, hydrophobic-hydrophilic separation (HHS), or a combination thereof.

6. The method of claim 5, wherein the physical separation method recovers particles less than 30 microns in diameter.

7. The method of claim 5, wherein the flotation and HHS processes comprise rendering the REE-bearing minerals hydrophobic using one or more hydrophobizing agents.

8. The method of claim 7, wherein the hydrophobizing agent is selected from alkyl and/or aryl hydroxamates and hydroxamic acids, cationic surfactant, anionic surfactant, fatty acids, non-ionic surfactant, or any combination thereof.

9. The method of claim 1, wherein the chemical extraction method comprises the steps of
a) admixing a preconcentrate with a base at a temperature less than or equal to 100° C. to displace the phosphate ions and produce REE oxides and hydroxides, and
b) leaching the REE oxides and hydroxides by (i) acid leaching, or (ii) by ion exchange leaching comprising ammonium sulfate or other lixiviants.

10. The method of claim 9, wherein the base comprises sodium hydroxide, potassium hydroxide, sodium carbonate, lime, or any combination thereof.

11. The method of claim 9, wherein the base is used at concentrations of 1% to about 80% by volume.

12. The method of claim 9, wherein the acid leaching is conducted at concentrations in the range of 0.1 M to 5 M.

13. The method of claim 9, wherein ammonium sulfate is used in combination with a chelating agent, a complex agent, or a combination thereof.

14. The method of claim 13, wherein the chelating agent is selected from organic acid, diamine, polyamine, hydroxamic acid, polyol, dicarboxylic acid, and mixtures thereof.

15. The method of claim 14, wherein the dicarboxylic acid is selected from maleic acid, succinic acid, glutamic acid, or any combination thereof.

16. The method of claim 13, wherein the chelating agent is ethylenediamine-tetracetate (EDTA).

17. The method of claim 13, wherein the complexing agent is selected from a sulfate, a formate, carboxylic acid, and any combination thereof.

18. The method of claim 1, wherein a chelating agent is used in combination with a base in step (a).

19. A method of extracting one or more rare earth elements (REEs) from a clayey REE source, comprising the steps of
a) subjecting the REE source to high-shear agitation in the presence of a polyelectrolyte to liberate REE-bearing minerals from the REE source;
b) separating the liberated REE-bearing minerals by a physical separation method to obtain a preconcentrate enriched with REEs; and
c) treating the preconcentrate with a phosphate solubilizing microorganism.

20. The method of claim 19, wherein the phosphate solubilizing microorganism is selected from bacteria comprising Atrophaeus, Paenibacillus macerans, Vibrio proteolyticus, Xanthobacter agilis, Pantoea aananatis, P. putida, Brevibacillus agri, B. subtilis, or Bacillus megaterium.

21. The method of claim 19, wherein the phosphate solubilizing microorganism is selected from fungi comprising Aspergillus niger or Aspergillus terreus.

22. A method of extracting one or more rare earth elements (REEs) from a clayey REE source, comprising the steps of:
a) subjecting the REE source to a physical separation process to obtain an enriched preconcentrate;
b) contacting the preconcentrate with concentrated sulfuric acid at a temperature above 150° C. to produce an acid-treated concentrate; and
c) contacting the acid-treated preconcentrate with water to extract both light and heavy rare earth elements into water to produce a leach liquor enriched with both light and heavy rare earth elements.

23. The method of claim 22, wherein the clayey REE source comprises anatase, wherein titanium ions and REE ions present in the leach liquor are separated from the leach liquor comprising the following steps:
a) adding a base to the leach liquor until the pH is raised to less than 5, wherein a precipitate comprising titanium dioxide is formed and a solution; and
b) separating the solution from the precipitate, wherein the solution is enriched with rare earth elements.

24. A method of extracting one or more rare earth elements (REEs) from a clayey REE source, comprising the steps of:
a) subjecting the REE source to high-shear agitation in the presence of a polyelectrolyte to liberate REE-bearing minerals from the REE source;
b) separating the liberated REE-bearing minerals by a physical separation method to obtain a preconcentrate enriched with REEs;
c) admixing a preconcentrate with a base at a temperature less than or equal to 100° C. to displace the phosphate ions and produce a first composition comprising REE oxides and hydroxides;
d) leaching the first composition by (i) acid leaching or (ii) by ion exchange leaching to produce a first leach liquor enriched with light rare earth elements and a leach residue;
e) contacting the leach residue with concentrated sulfuric acid at a temperature above 150° C. to produce an acid-treated product;
f) contacting the acid-treated product with water to obtain a second leach liquor comprising heavy rare earth elements and titanium ions; and
g) precipitating titanium dioxide by raising the pH to less than 5, leaving the second leach liquid enriched with heavy rare earth elements.
